(19) United States
(12) Patent Application Publication
(10) Pub. No.: US 2009/0126677 A1
(43) Pub. Date: May 21, 2009

(54) Device comprising a functional element of an internal combustion engine and a carrier

(75) Inventor: Hans-Joachim Vom Stein, Odenthal (DE)

Correspondence Address: Mark A. Ussai;SKF USA Inc., 1111 Adams Avenue, Norristown, PA, 19403, US

(73) Assignee: Aktiebolaget SKF, Goteborg (SE)

(21) Appl. No.: 12/284,119

(22) Filed: Sep. 18, 2008

(30) Foreign Application Priority Data
Oct. 18, 2007 (DE) 10 2007 044 494.1

(51) Int. Cl. F02B 67/00

(52) U.S. Cl. 123/198 C

(57) ABSTRACT

A device includes a functional element of an internal combustion engine and a carrier fastened to a load-bearing structure on or in the internal combustion engine, preferably by a plurality of fastening elements. In order to obtain insensitiveness with respect to thermal deformations, the invention provides that the connection between the functional element and carrier is formed by means of at least one connecting wall which is composed of elastomeric material or of rubber material. The connecting wall extends at least generally parallel to and is spaced from a holding section of the carrier so as to define an air gap between the connecting wall and the carrier holding section.

This application claims priority to German Patent Application No. DE 10 2007 044 494.1, filed Sep. 18, 2007, the entire contents of which are incorporated herein by reference.

### BACKGROUND OF THE INVENTION

The invention relates to internal combustion engines, more particularly to devices for connecting functional elements or components with an internal combustion engine.

Devices for internal combustion engines are known. In particular, devices are known for holding a functional element on or in an internal combustion engine in a vibration-isolated manner.

### SUMMARY OF THE INVENTION

In one aspect, the present invention is a device comprising a functional element of an internal combustion engine and a carrier attached to a load-bearing structure on or in the internal combustion engine and having a holding section. The carrier is connected with the functional element by a wall formed of an elastomeric material or a rubber material, the connecting wall extending at least generally parallel to and being spaced from the carrier holding section so as to define an air gap between the wall and the carrier section.

The present invention is directed developing a device of the type specified in the background section in such a way as to achieve a relatively light weight construction which is provides a relatively highly reliable sealing action. The device is also directed to providing favourable acoustic properties, and specifically having a relatively high level of vibration damping to achieve favourable acoustic properties.

The achievement of said object by means of the invention is characterized in that the connection between the functional element and the carrier is formed by means of at least one wall which is composed of elastomeric material or of rubber material, with the wall running substantially parallel to a holding section of the carrier, and with an air gap which runs parallel to the wall and to the holding section remaining between the wall and the holding section.

The functional element or component is preferably an oil sump, but may be any other component suspended from the engine.

The carrier is preferably formed in the manner of a frame, and most preferably includes one or more metal sheets or plates connected to form the frame-like carrier.

The holding section of the carrier, the wall and the air gap may extend substantially in the vertical direction.

The holding section of the carrier may have an end have a support section which extends substantially perpendicular to the holding section. It may correspondingly be provided that the functional element has a wall which extends parallel to the holding section of the carrier, with the wall having, at one of its ends, a support section which extends substantially perpendicular to the wall. In this case, it is preferably provided that the support section which is arranged on the holding section and the support section which is arranged on the wall overlap in the direction perpendicular to the holding section and to the wall.

The holding section may be encapsulated with the elastomeric material or rubber material, with the wall between the functional element and carrier also being formed from said elastomeric material or rubber material.

Screws are preferably used as fastening elements.

The carrier is preferably composed of sheet metal. The functional element may however be composed of plastic.

The elastomeric material or rubber material which forms the wall and which, if appropriate, encapsulates the holding section may be connected to adjoining components by means of an adhesive. Plasma activation may also be provided.

With the solution according to the invention, it is obtained that, even in the event of intense temperature changes in the system, temperature-induced expansions may take place without it being possible for a stress to build up in the device.

Furthermore, the proposed construction serves to ensure vibration-deadening or dampening suspension of the functional part of the internal combustion engine.

It is also advantageous that the construction which is preferably provided is particularly suitable for suspended functional parts, with consideration being given in particular to oil sumps, since the connection, which acts as a diaphragm, composed of elastomeric or rubber material between the carrier and the functional part is in this case held under compressive stresses at all times, and therefore varies only minimally over the service life of the internal combustion engine.

The preferred concept also ensures that the functional part is not torn off or sheared in the event of failure of the elastomeric or rubber component, and the connection to the functional part is ensured, such that the proposed construction meets stringent safety demands.

### BRIEF DESCRIPTION OF THE SEVERAL VIEWS OF THE DRAWINGS

The foregoing summary, as well as the detailed description of the preferred embodiments of the present invention, will be better understood when read in conjunction with the appended drawings. For the purpose of illustrating the invention, there is shown in the drawings, which are diagrammatic, embodiments that are presently preferred. It should be understood, however, that the present invention is not limited to the precise arrangements and instrumentalities shown. In the drawings:

FIG. 1 is a broken-away, cross-sectional view of an exemplary embodiment of the invention, showing an edge section of an oil sump of an internal combustion engine, the oil sump being shown fixed to the internal combustion engine by means of a screw connection.

### DETAILED DESCRIPTION OF THE INVENTION

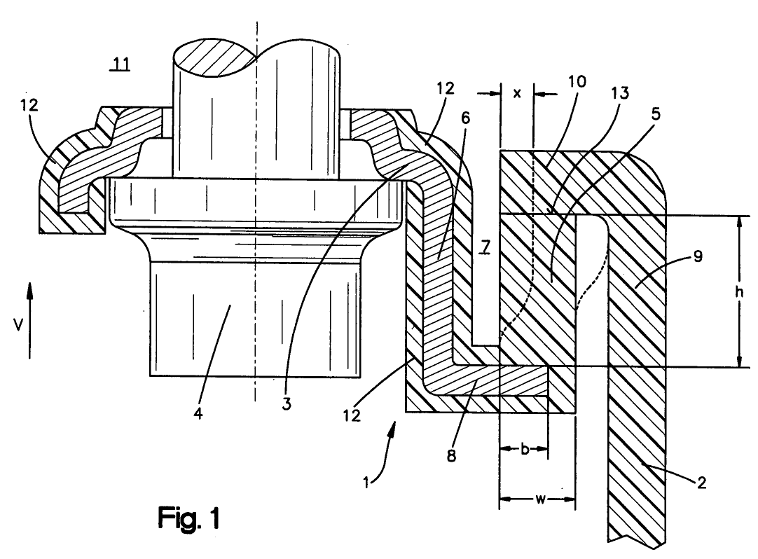

Referring now to the drawing in detail, wherein like numbers are used to indicate like elements throughout, there is shown in FIG. 1 a device 1 comprising a functional part or component 2 of an internal combustion engine, preferably an oil sump, and a carrier 3. The oil sump 2 is preferably formed of plastic and is fastened to the internal combustion engine, preferably in the base region of the latter, in any known, appropriate manner. The carrier 3 preferably function to connect the oil sump 2 to the engine and is fastened or attached to the underside of the engine block 11, the block 11 being indicated only schematically. The carrier 3 is preferably attached or fastened to the engine block 11 by at least one and preferably a plurality of fastening elements 4 (only one shown), which are most preferably formed as screws.

The carrier 3 is preferably constructed as a frame composed or formed of a plurality of metal members or sheets (e.g., plates). The metal sheets/plates are preferably encapsulated with/by an elastomeric material or rubber material 12, so as to form a frame unit.

The carrier 3 has, on a side facing toward the oil sump 2, a holding section 6 which extends as a wall generally in a vertical direction V. The holding section 6 has a lower end and a support section 8 at the lower end, which adjoins or connects with the holding section 6 generally at right angles, such that the support section 8 runs or extends at least generally horizontally, and generally perpendicularly, with respect to a remainder of the holding section 6.

The oil sump 2 further has a wall 9 which extends at least generally in the vertical direction V. The oil sump wall 9 has an upper end and a support section 10 at the upper end, the support section 10 extending at least generally perpendicular to a remainder of the wall 9. As can be seen in FIG. 1, the holding section 6 of the carrier 3, the wall 9 of the oil sump, and the two horizontally-extending support sections 8 and 10 are formed such that an overlap is generated or formed, as seen in the vertical direction V, which overlap extends over a width “b”. In other words, the support sections 8 and 10 overlap each other by a width or distance “b”.

The oil sump 2 and the carrier 3 are preferably connected by means of a wall 5 which is composed or formed of elastomeric material, rubber material, or any generally similar material. As can be seen, the connecting wall 5 runs or extends substantially parallel to the holding section 6 of the carrier 3 and is spaced from the holding section such that an air gap 7 is defined between the connecting wall 5 and the holding section 6, taking into consideration the encapsulation of the holding section 6 with elastomeric material or rubber material. In other words, the air gap 7 runs or extends generally parallel with the connecting wall 5 and the holding section 6, and may be at least partially occupied or filled with the material 12 encapsulating the holding section 6.

The connecting wall 5 has both a width w and a height h, which are plotted or indicated in FIG. 1. The values of width w and height h are selected by a person skilled in the art so as to generate desired body-borne sound deadening or damping properties of the wall 5. Preferably, the height h of the wall 5 is between about one and a half (1.5) times the width w to about three (3) times the width w of the wall 5, and the wall 5 is preferably of generally planar design.

In FIG. 1, the solid lines denote the position of the components in the state at room temperature. If the device 1 is heated, a temperature-induced displacement of the components occurs. Such displacement is indicated—in exaggerated form—in FIG. 1 by the dashed lines for the wall 5. Specifically, FIG. 1 depicts the oil sump 2 as being displaced by an amount x as a result of a thermal deformation; in other words, the connecting wall 5 is deformed as indicated.

However, due to the material properties of the elastomeric material, rubber material, or similar material forming the wall 5, stress compensation occurs. That is, the design of the connecting wall 5 with an adjoining air gap 7 functions as a diaphragm and allows the thermal expansion to be absorbed without a significant build-up of stress in the material.

The carrier frame, preferably formed of metal sheets, is thus connected with the oil sump 2, which is preferably formed or composed of plastic, using elastomeric or rubber material which forms the connecting wall 5 and which is also used for the encapsulation and connection of the individual parts of the frame. The wall 5 formed/composed of elastomeric or rubber material is disposed between the holding section 6 of the carrier 3 and of the wall 9 of the oil sump 2 so as to form a type of diaphragm which permits simple and efficient compensation of temperature-induced displacements.

More specifically, the holding section 6 and the support section 8 of the carrier 3, the connecting wall 5, and the support section 10 and the wall 9 of the oil sump 2 form, in cross section, a meandering or flexible profile which can optimally absorb or permit a displacement of the wall 9 relative to the holding section 6 in the horizontal direction.

Preferably, a transition region or interface between the support section 10 and the connecting wall 5 is formed as a plasma-activated region 13.

The diaphragm formed by the connecting wall 5 and sections of the sump 2 and the carrier 3 permits a different thermal length expansion of the components without a significant build-up of stress (no warping in the metal frame), and targeted influencing of the spring characteristic of the body-borne sound decoupling of the plastic oil sump 2, by means of the modification of the dimensions a and h.

The construction is particularly suitable for suspended components, such as oil sumps, since the diaphragm is subjected to a relatively constant pressure loading, and therefore varies only to a limited extent over the service life.

A further advantage of the present invention is the prevention of tearing off or shearing in the event of failure of the elastomeric or rubber component or of the connection to the plastic material of the oil sump 2.

This construction is, in this respect, a pressure-loaded metal-frame/plastic functional part construction.

The invention is particularly applicable or suitable where it is desired to replace an oil sump composed or formed of pressure-die-cast aluminium with an oil sump composed of plastic material.

However, oil sumps are not the only possible application of the present invention. For example, the present invention may be advantageously used with any type of cover which provides acoustic damping, in particular in connection with an oil-tight arrangement.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as generally defined in the appended claims.

### LIST OF REFERENCE SYMBOLS

1 Device
2 Functional element (oil sump, sound deadening cover)
3 Carrier
4 Fastening element
5 Wall
6 Holding section
7 Air gap
8 Support section
9 Wall
10 Support section
11 Engine block
12 Elastomeric material/rubber material
13 Plasma-activated region
V Vertical direction
b Extent of overlap
w Width of the wall
h Height of the wall
x Deflection as a result of thermal deformations (thermal compensation)

I claim:

1. A device comprising:
a functional element of an internal combustion engine; and
a carrier attached to a load-bearing structure one of on and in the internal combustion engine and having a holding section, the carrier being connected with the functional element by a wall formed of one of an elastomeric material and a rubber material, the connecting wall extending at least generally parallel to and being spaced from the carrier holding section so as to define an air gap between the wall and the carrier section.

2. The device according to claim 1, wherein the functional element is an oil sump.

3. The device according to claim 1, wherein the carrier is formed as a frame.

4. The device according to claim 1, wherein the holding section of the carrier, the connecting wall, and the air gap extend in a substantially vertical direction.

5. The device according to claim 1, wherein the holding section of the carrier has an end and a support section at the end, the support section extending at least generally perpendicular to a remainder of the holding section.

6. The device according to claim 1, wherein the functional element has a wall extending at least generally parallel to the holding section of the carrier, the functional element wall having an end and a support section at the end, the functional element support section extending at least generally perpendicular to a remainder of the wall.

7. The device according to claim 6, wherein the support section of the carrier holding section and the support section of the functional element wall overlap in a direction generally perpendicular to the holding section and to the functional element wall.

8. The device according to claim 1, wherein the carrier holding section is encapsulated with one of an elastomeric material and a rubber material, and the connecting wall between the functional element and carrier is formed from the one of the elastomeric material and the rubber material.

9. The device according to claim 1, wherein the carrier section is attached to the load-bearing structure by at least one fastening element.

10. The device according to claim 9, wherein the at least one fastening element is a screw.

11. The device according to claim 1, wherein the carrier is formed of sheet metal.

12. The device according to claim 1, wherein the functional element is formed of plastic.

13. The device according to claim 1, wherein the material forming the connecting wall encapsulates the holding section.

14. The device according to claim 1, wherein the carrier wall is connected with the functional element by an adhesive.

15. The device according to claim 1, wherein the material of the carrier wall is plasma-activated for adhesion to the functional element.
